(19) United States
(12) Patent Application Publication
(10) Pub. No.: US 2017/0215401 A1
(43) Pub. Date: Aug. 3, 2017

(54) AQUA OXUGEN ALERT

(71) Applicant: Jimmie C. Ellis Il, Ozark, AL (US)

(72) Inventor: Jimmie C. Ellis Il, Ozark, AL (US)

(21) Appl. No.: 15/397,111

(22) Filed: Jan. 3, 2017

Related U.S. Application Data
(60) Provisional application No. 62/288,419, filed on Jan. 28, 2016.

(51) Int. Cl. A01K 97/20; B63B 35/26; G08B 21/18; A01K 97/04

(52) U.S. Cl. CPC A01K 97/20; A01K 97/04; B63B 35/26; G08B 21/182

(57) ABSTRACT

A live well oxygen and temperature level alert and control apparatus including a temperature sensor and oxygen sensor con figured to sense the temperature and oxygen level of a live well. The sensed signal is seat to a controlling and monitoring apparatus. The controlling and monitoring apparatus is linked to a heating or cooling control system of the live well. Further, the alert apparatus may be configured to control the supply of the fresh or salt replacement water to the live well by controlling a valve supplying such water. The controlling and monitoring apparatus is configured to alert a user about the oxygen and temperature level of the water inside the live-well and control these levels via a user interface. The further inventive aspects can be embodied in one or more of a display screen, a speaker, and an alarm for communicating oxygen and temperature level to a user.

### CROSS REFERENCE TO RELATED APPLICATION

This application claims priority to U.S. Provisional Patent application No. 62/288,419 filed on Jan. 28, 2016, which is incorporated herein in its entirety by reference.

### FIELD

Example embodiments described here generally relate to a system for keeping fish in a live well by maintaining appropriate temperature and oxygen levels.

### BACKGROUND

Over recent years, recreational and sport fishing has grown considerably in popularity as well as sophisticated with the advent of mote scientifically-designed fishing equipment and techniques. As part of this trend, various technical and design improvements in recreational fishing boats have evolved, one such improvement being the provision of an inboard water reservoir or tank, commonly referred to as a “live well” for containing a quantity of water which stores captured fishes to maintain them alive for a reasonable period in captivity.

Conventional live well systems or methods in modern recreational fishing boats typically provide a battery-operated electric water pump for selectively filling the tank with water from the ambient body of water in which the boat is being operated and an overflow discharge line to establish a maximum level of water in the tank to prevent overfilling thereof More sophisticated live wells also provide a pump-operated aeration system for withdrawing water contained in the tank and spraying it in return into the tank to replenish any oxygen from the water consumed by fish stored therein. The pump's intake is below the water line and its discharge is in to the tank. The water level in the tank is controlled generally by a drain tube which discharges extra or unwanted water overboard. The aerated water is important so as to keep the live fish fresh and active. It is also vital for tournament fishing contests where the catch is kept alive and reasonably healthy after which it is weighed and then released back into the body of water from which it was taken.

U.S. Patent application No. 20120223152 A1 to Hairgrove, discusses a method for dispensing a liquid live release formula from a pre-filled tank and pump directly into an internal live well of a bass boat for simplifying fish care for the purpose of prolonging the life of a captive fish being transported.

U.S. Pat. No. 6,557,492 B1 to Robohm, discusses a live fish transport system which consists of a modular live fish transport tote, an oxygen delivery system, an automated water treatment and delivery apparatus and a chemically and biologically balanced aquaculture solution.

U.S. Pat. No. 6,038,993 A to Vento, discusses a live well aeration system in which a pump is used to pump water from a sea chest to a bait well containing live bait, wherein the sea chest is provided with a vent line for releasing air from the sea chest, thereby preventing air from entering the pump and causing air lock.

U.S. Pat. No. 5,172,511 A to Smith et al., discusses a fish or fish bait preservation apparatus and method utilizing ice as a coolant. It pipes bait or fish containing water there to maintain the water at an automatic electronically control led temperature and returning water that has been cooled to a fish or bait tank through a conductor having an aerating nozzle.

U.S. Pat. No. 5,632,268 A to Ellis et al., discusses ail improved oxygen delivery system to use in a fishing vessel which is capable of oxygenating individual live-well holding tanks to sustain the fish and minnows within.

Despite the above-described provisions in the most sophisticated conventional live wells for maintaining a relatively clean body of contained water and for continuously aerating the water, experience has shown that even the most sophisticated live wells are incapable of reliably maintaining captured fish for more than one to three hours without proper maintenance of oxygen and temperature control.

In view of the foregoing, it is an object of the present disclosure to provide an alert apparatus in communication with the live well for assisting the angler in maintaining oxygen levels which eliminates or minimizes the above mentioned and other problems, limitations and disadvantages.

### SUMMARY

In view of the preceding disadvantages inherent in fee known types of oxygen maintenance and monitoring apparatus or related devices in the prior art, the present disclosure provides an improved alarm device to measure and indicate oxygen levels, temperature within a live well and raise an alarm if the oxygen level depletes to an unsafe level. As such, the general purpose of the present disclosure, which will be described subsequently in greater detail, is to provide a new and improved water well alert apparatus.

The inventive aspect described in the specification can be embodied in a live well oxygen level alert system including at least one temperature sensor connected to a temperature setting mechanism, where the temperature setting mechanism controls a heating and cooling mechanism for a live well and at least one oxygen sensor connected to an oxygen level mechanism, wherein the oxygen level mechanism controls an oxygenation, mechanism for a live well. The further inventive aspects can be embodied in one or more of a display screen, a speaker, and an alarm for communicating one or both of a temperature and oxygen level, wherein the alert system is mounted within a live well for storing fish.

The other inventive aspects can be embodied in a temperature setting mechanism that allows a user to increase or decrease the temperature of the live well containing live fish and an oxygen level setting mechanism to allow the user to increase or decrease the target oxygen level reading in the live well containing live fish.

Yet other inventive aspects can be embodied wherein the speaker or alarm produces an alert sound for one or both of the temperature and the oxygen level outside of a targeted safe range. A power on/off button is provided to activate the system after it is successfully installed in the live well or deactivate the system alter its use.

The inventive aspect described in the specification can be embodied in a live well oxygen level alerting apparatus for a boat comprising sensors within a wall of a live well, wherein the sensors are secured in place with a locking unit and include one or more signal sending and receiving wires connected with one or more sensor probes.

Accordingly, it is an object of the present disclosure to provide an apparatus to be placed in live wells on fishing boats to alert a user about a temperature and oxygen level in a live well. It is an object of the present disclosure to provide an alert apparatus to help eliminate fish from dying in a catch and release format, by installing the apparatus in a live well of a boat to alert an angler about depleted oxygen levels the live well. It is a further object of the present disclosure to provide a system for using the disclosed apparatus to safely transport and store live fish over extended periods of time with low-mortality. It is another object of the present disclosure to provide an oxygen monitoring apparatus that is easy to install, maintain, low in cost, reliable, and safe.

### BRIEF DESCRIPTION OF THE DRAWINGS

The example embodiments of the inventive concept will be better understood from the following brief description taken in conjunction with the accompanying drawings. The drawing FIGS. 1-4 represent non-limiting, example embodiments:

FIG. 1 shows the sensing system of present disclosure installed in live wells, according to an example embodiment.

FIG. 2 shows a front view of control and alert interface, according to an example embodiment.

FIG. 3 shows side view of the control interface, according to an example embodiment.

FIG. 4 shows back view of the control interface, according to an example embodiment.

### DETAILED DESCRIPTION

In the following description, reference is made to the accompanying drawings which form a part hereof, and in which is shown by was of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, some dimensions are exaggerated for clarity.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”,“comprising”,“includes”and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In some preferred embodiments, the present disclosure provides improved alert apparatus to protect fish stored in live wells from dying due to a depleted oxygen level. The purpose of the disclosure is to provide a user friendly and easy to use and install apparatus for live wells.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

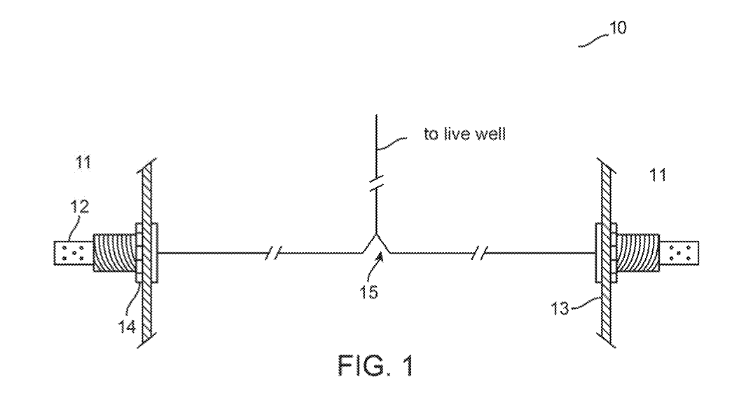

FIG. 1 shows a live well monitoring apparatus 10 to be installed in live wells 11. The sensing probe 12 may be connected with the wall 13 of the live well 11 and secured in place using a locking unit 14. A signal sending and receiving wire 15 is connected to the sensing probe 12 at one end.

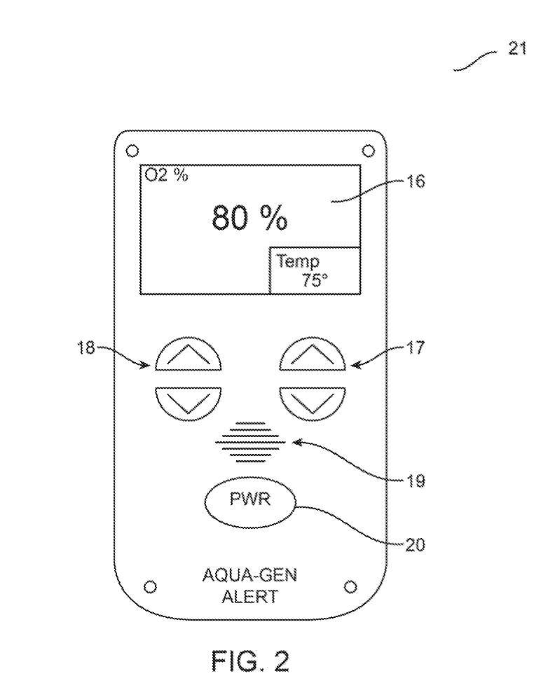

FIG. 2 shows the alert apparatus 21 comprising a display, a temperature and oxygen maintenance buttons, a speaker or alarm, and a power button. The signal from the sensing probe 12 is received directly through the wires 15 or it may be received wirelessly. The display screen 16 shows the level of oxygen in terms of percentage as well as the temperature of the live well. Temperature maintaining interface comprise buttons 17 and may be used to adjust and target an appropriate temperature. Likewise, oxygen level maintaining interface buttons 18 are used to target an appropriate oxygen level to maintain the vitality of the fish. If the oxygen level becomes depleted, a speaker or alarm 19 may sound to raise an alarm and alert a user. The system may also include other common features of an electric apparatus including a power on/off button 20 for activating or deactivating the alert apparatus.

In an example embodiment, the alert apparatus is linked to a control system for controlling oxygen level and controlling temperature of the live well. For example, the system may be used with conventional tanks that are customarily fitted with a pump to supply aerated fresh or salt replacement water to the live well. The alert apparatus may be configured to control the supply of the fresh or salt replacement water to the live well by controlling a valve supplying such water wirelessly. In another example embodiment, such alert and control may be performed by a mobile device connected to the internet through Wi-Fi.

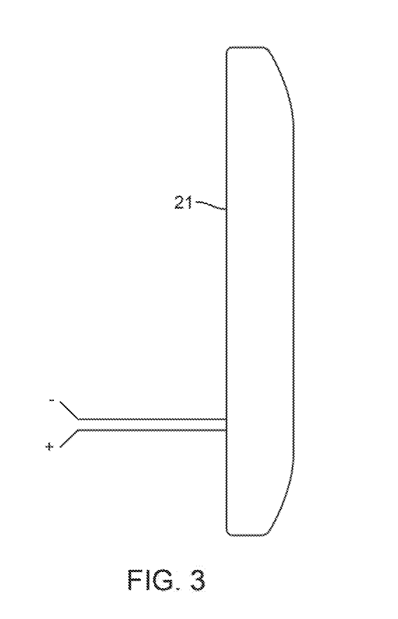

FIG. 3 shows the apparatus 21 provided with power supply wires at the hack of the apparatus 21. The apparatus may be approximately 3-5 inches long to fit one or more live well apparatus 10.

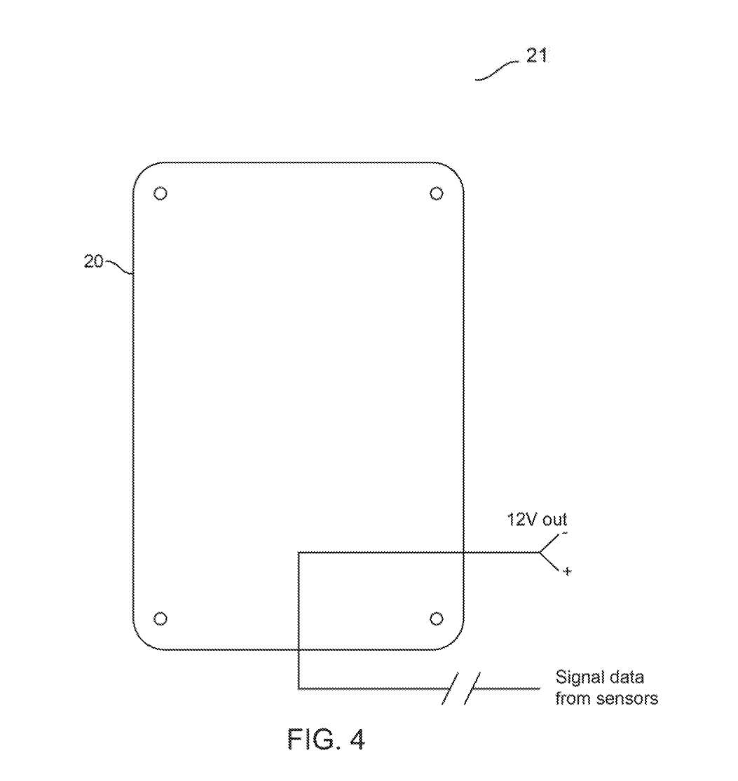

FIG. 4 shows the apparatus 21 provided with the back holes for mounting the apparatus 10 within the live well 11. Thus, the apparatus may be easily and efficiently mounted tor live well apparatus. The monitoring system may also necessitate a design of a live well to better accommodate the apparatus.

In an example embodiment, the system allows a user to maintain the common requirement of fishing tournaments, such as bass fishing, that the fish caught must be maintained in a live condition and released back into a lake or other body of water at the end of the tournament. Thus, the system will especially enable a user to keep fish in good physical condition for extended periods. The system may be used in most fishing boats that are equipped with one or more holding tanks, such as live well tanks for live bait that can be used to keep fish, which have been caught alive. The system may be used with conventional tanks that are customarily fitted, with a pump to supply aerated fresh or salt replacement water to the tank.

In an example embodiment, the live well apparatus and method can reliably maintain captured fish for extended periods of time, including up to approximately twelve to sixteen hours. This is sufficient time to cover an entire day of fishing. The apparatus assists the angler to preserve the fish with appropriate oxygen levels and will alert the user if the oxygen level depletes to an unsafe level.

In an example embodiment, the system and method are designed to alert the angler if the water of the live well becomes too warm. The aim of such an alert is to alert the angler to cool the water contained in the live well tank to a temperature sufficiently reduced to induce a state of slowed metabolism of the gamefish while maintaining appropriate oxygen levels. In this manner, the captive life of the fish is prolonged by effectively calming any excited tendency of the fish and further to reduce or eliminate impurities including excrement and foreign matter in the live well.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

What is claimed is:

1. A live well sensing and alert system, the system comprising:
at least one temperature sensor connected to a temperature control interface, wherein the temperature control interface is configured to control heating and cooling system of the live well based on the signal received from the temperature sensor;
at least one oxygen sensor connected to an oxygen level control interface, wherein the oxygen level control interface is configured to control the water oxygenation for the live well; and
one or more of a display screen, a speaker, and an alarm for communicating one or both of a temperature and oxygen level.

2. The system of claim 1, wherein the sensing and alert system is mounted within the live well for storing fish.

3. The system of claim 1, wherein temperature control interface allows a user to increase or decrease the temperature of the live well.

4. The system of claim 1, wherein the oxygen level control interface allows a user to increase or decrease fee target oxygen level in the live well.

5. The system of claim 1, wherein the speaker or alarm is configured to generate an aim sound for one or both of the temperature and the oxygen level outside of a safe range.

6. The system of claim 1, wherein a power on/off button is provided to activate the system after installation in the live well or deactivate the system after its use.

7. A live welt sensing and alerting apparatus for a boat comprising:
one or more sensor probes installed in a wall of the live well, wherein the sensor probes are secured in place with a locking unit and include one or more signal sending and receiving wires connected with the one or more sensor probes.
